(19) United States
(12) Patent Application Publication
(10) Pub. No.: US 2015/0205432 A1
(43) Pub. Date: Jul. 23, 2015

(54) TOUCH SENSOR AND DISPLAY DEVICE INCLUDING THE SAME

(71) Applicant: Samsung Display Co., Ltd., Yongin-city (KR)

(72) Inventors: Soon-Sung AHN, Yongin-city (KR); Ja-Seung Ku, Yongin-city (KR); Hyoung-Wook Jang, Yongin-city (KR)

(21) Appl. No.: 14/584,846

(22) Filed: Dec. 29, 2014

(30) Foreign Application Priority Data
Jan. 21, 2014 (KR) 10-2014-0007223

(51) Int. Cl. G06F 3/041; G06F 3/044

(52) U.S. Cl. CPC G06F 3/0416; G06F 3/0412; G06F 3/044

(57) ABSTRACT

A touch sensor including driving electrodes, sensing electrodes, a memory, and a driver. The sensing electrodes intersect the driving electrodes. The memory stores a code matrix including driving codes respectively set for the driving electrodes and driving periods. The driver supplies driving signals to the driving electrodes with reference to the code matrix. In the touch sensor, the code matrix is configured with m rows and n columns, where m is an integer greater than or equal to 2, and n=m−1.

### CROSS-REFERENCE TO RELATED APPLICATION

This application claims priority from and the benefit of Korean Patent Application No. 10-2014-0007223, filed on Jan. 21, 2014, which is hereby incorporated by reference for all purposes as if fully set forth herein.

### BACKGROUND

1. Field

Exemplary embodiments of the present invention relate to a touch sensor and a display device including the same.

2. Discussion of the Background

Recently, a digitizer, a touch screen, and the like have been widely used, and can replace existing input devices such as a keyboard and/or a mouse, by directly detecting a contact position of a user's hand or object.

Each of these devices has a touch sensor configured to detect a touch position. For example, the touch sensor may be a capacitive type touch sensor, a resistive overlay type touch sensor, a photosensitive type touch sensor, etc.

Among these touch sensors, the capacitive type touch sensor is used to sense a touch position by detecting a point at which capacitance is changed according to the contact of a user's hand or object. The capacitive type touch sensor has recently come into wide use because of its relative ease of multi-touch detection and excellent accuracy.

The above information disclosed in this Background section is only for enhancement of understanding of the background of the invention and, therefore, it may contain information that does not constitute prior art.

### SUMMARY

Exemplary embodiments of the present invention provide a touch sensor including a memory configured to store a code matrix including driving codes respectively set for the driving electrodes and driving periods; and a driver configured to supply driving signals to the driving electrodes with reference to the code matrix.

Additional features of the invention will be set forth in the description which follows, and in part will become apparent from the description, or may be learned from practice of the invention.

An exemplary embodiment of the present invention discloses a touch sensor, including: driving electrodes; sensing electrodes configured to intersect the driving electrodes; a memory configured to store a code matrix including driving codes respectively set for the driving electrodes and driving periods; and a driver configured to supply driving signals to the driving electrodes with reference to the code matrix. The code matrix is configured with m rows and n columns, where m is an integer greater than or equal to 2, and n=m−1.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a touch sensor according to an exemplary embodiment of the present invention.

FIG. 2 is a waveform diagram illustrating driving signals for the touch sensor illustrated in FIG. 1.

FIG. 3 is a diagram illustrating a controller according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of elements may be exaggerated for clarity. Like reference numerals in the drawings denote like elements.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

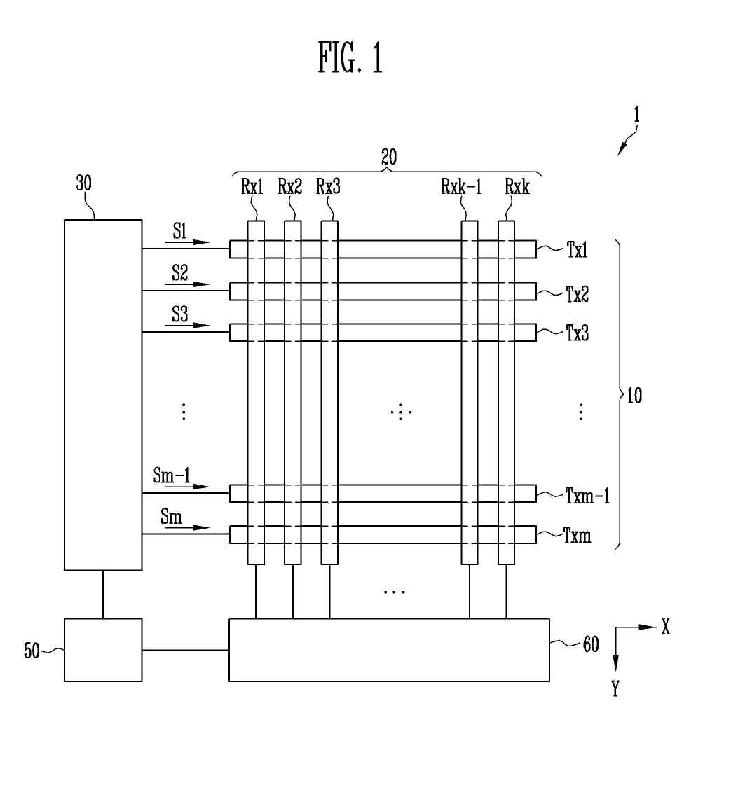

Referring to FIG. 1, a touch sensor 1 according to an exemplary embodiment may include driving electrodes 10, sensing electrodes 20, a driver 30, a memory 50, and a controller 60.

The driving electrodes 10 may be formed to extend in a first direction (e.g., an X-axis direction) and arranged along a second direction (e.g., a Y-axis direction) intersecting the first direction.

For example, the driving electrodes 10 may include first to m-th driving electrodes Tx1 to Txm, as shown in FIG. 1.

The sensing electrodes 20 are spaced apart from the driving electrodes 10, so that the driving electrodes 10 and the sensing electrodes 20 can be operated as a capacitive type touch sensor.

The sensing electrodes 20 may be disposed to intersect the driving electrodes 10. Although FIG. 1 shows that the driving electrodes 10 are positioned below the sensing electrodes 20, the driving electrodes 10 may alternatively be positioned above the sensing electrodes 20.

The sensing electrodes 20 may be formed to extend in the second direction (e.g., the Y-axis direction) and may be arranged in the first direction (e.g., the X-axis direction).

For example, the sensing electrodes 20 may include first to k-th sensing electrodes Rx1 to Rxk, as illustrated in FIG. 1.

Through the arrangement of the driving electrodes 10 and the sensing electrodes 20, mutual capacitance between the driving electrode 10 and the sensing electrode 20 is formed at a point where the driving electrode 10 and the sensing electrode 20 intersect each other. Each intersection point may be operated as a sensing cell which implements touch recognition.

The driving electrodes 10 and the sensing electrodes 20 may be formed of a transparent conductive material. However, the driving electrodes 10 and the sensing electrodes 20 may be formed of other conductive materials, such as an opaque metal. For example, the driving electrodes 10 and the sensing electrodes 20 may be formed of indium tin oxide (ITO), indium zinc oxide (IZO), graphene, carbon nanotubes, silver nanowires (AgNWs), or the like.

The memory 50 may perform a function of storing a code matrix Mcode.

The code matrix Mcode may include driving codes D respectively set for the driving electrodes Tx1 to Txm and driving periods t1 to tn.

For example, the code matrix Mcode may include the following m×n matrix:

$$[ \begin{matrix}D ( Tx 1 , t 1 ) & D ( Tx 1 , t 2 ) & D ( Tx 1 , t 3 ) & … & … & D ( Tx 1 , tn ) \\ D ( Tx 2 , t 1 ) & D ( Tx 2 , t 2 ) & D ( Tx 2 , t 3 ) & … & … & D ( Tx 2 , tn ) \\ D ( Tx 3 , t 1 ) & D ( Tx 3 , t 2 ) & D ( Tx 3 , t 3 ) & … & … & D ( Tx 3 , tn ) \\ ⋮ & ⋮ & ⋮ & & & ⋮ \\ ⋮ & ⋮ & ⋮ & & & ⋮ \\ D ( \begin{matrix}Txm - 1 , \\ t 1\end{matrix} ) & D ( \begin{matrix}Txm - 1 , \\ t 2\end{matrix} ) & D ( \begin{matrix}Txm - 1 , \\ t 3\end{matrix} ) & … & … & D ( \begin{matrix}Txm - 1 , \\ tn\end{matrix} ) \\ D ( Txm , t 1 ) & D ( Txm , t 2 ) & D ( Txm , t 3 ) & … & … & D ( Txm , tn )\end{matrix} ]$$

Here, m is the number of the driving electrodes 10, and may be an integer greater than or equal to 2. In addition, n is the number of the driving periods t1 to tn. Particularly, the n may be set to m−1. That is, when the code matrix Mcode of m×m−1 is used, the operating process of the code matrix Mcode of m×m−1 can be further simplified than when a code matrix of m×m is used.

Rows of the code matrix Mcode may correspond to the respective driving electrodes Tx1 to Txm, and columns of the code matrix Mcode may correspond to the respective driving periods t1 to tn.

That is, each row of the code matrix Mcode includes driving codes corresponding to the respective driving periods for each specific driving electrode, and each column of the code matrix Mcode includes driving codes corresponding to the respective driving electrodes for each specific driving period.

For example, an m-th row of the code matrix Mcode may include driving codes D(Txm, t1), D(Txm, t2), . . . , and D(Txm, tn) corresponding to the respective driving periods t1 to tn of an m-th driving electrode Txm, and an n-th column of the code matrix Mcode may include driving codes D(Tx1, tn), D(Tx2, tn), . . . , D(Txm, tn) corresponding to the respective driving electrodes Tx1 to Txm in an n-th period tn.

Each driving code D included in the code matrix Mcode may have a value of A or −A. For example, A may be set to a natural number.

In this case, an exemplary embodiment of the code matrix Mcode may be shown as follows:

$$[ \begin{matrix}A & A & A & … & … & A & A \\ - A & A & - A & … & … & A & - A \\ A & - A & - A & … & … & - A & - A \\ ⋮ & ⋮ & ⋮ & & & ⋮ & ⋮ \\ ⋮ & ⋮ & ⋮ & & & ⋮ & ⋮ \\ A & - A & - A & … & … & A & A \\ - A & - A & A & … & … & A & - A\end{matrix} ]$$

The driver 30 may supply driving signals S1 to Sm to the driving electrodes 10. For example, the driver 30 may simultaneously supply the driving signals S1 to Sm to the m driving electrodes Tx1 to Txm. The driver 30 may be electrically coupled to the driving electrodes 10.

In this case, each of the driving signals S1 to Sm may have a first voltage V1 or a second voltage V2 applied thereto. For example, the first and second voltages V1 and V2 may be set to have the same absolute value and opposite polarities.

In this exemplary embodiment, the driver 30 may supply the driving signals S1 to Sm to the driving electrodes with reference to the code matrix Mcode stored in the memory 50. In particular, the driver 30 may output the driving signals S1 to Sm with reference to driving codes D respectively set for the driving electrodes Tx1 to Txm and the driving periods t1 to tn.

For example, when a specific driving code is set to A, the driver 30 may supply the first voltage V1 to a corresponding driving electrode in a corresponding period. When the specific code is set to −A, the driver 30 may supply the second voltage V2 to the corresponding driving electrode in the corresponding period.

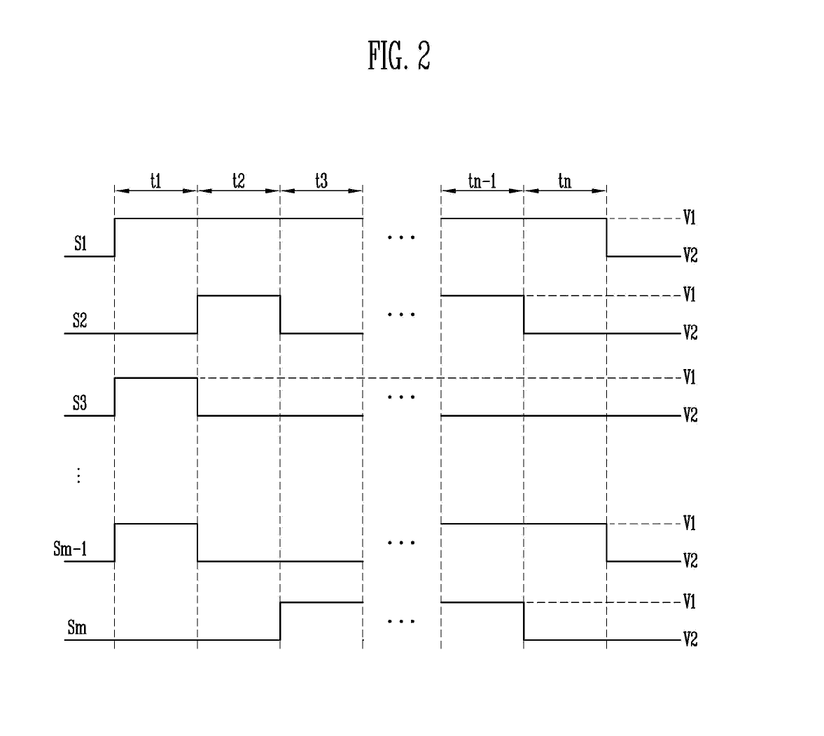

An operation of the driver 30 will be described in detail with reference to the exemplary embodiment of the code matrix Mcode and FIG. 2.

In case of the first row with respect to the first driving electrode Tx1 in the code matrix Mcode, the driving codes are set to A during all the driving periods t1 to tn. Therefore, as shown in FIG. 2, the driver 30 may supply a driving signal S1 having the first voltage V1 to the first driving electrode Tx1 during all the driving periods t1 to tn.

In case of the second row with respect to the second driving electrode Tx2 in the code matrix Mcode, the driving code is set to −A in the first driving period t1, the driving code is set to A in the second driving period t2, the driving code is set to −A in the third driving period t3, the driving code is set to A in the (n−1)-th driving period tn−1, and the driving code is set to −A in the n-th driving period tn.

Therefore, the driver 30 may supply the second voltage V2 to the second driving electrode Tx2 during the first driving period t1; supply the first voltage V1 to the second driving electrode Tx2 during the second driving period t2; supply the second voltage V2 to the second driving electrodes Tx2 during the third driving period t3; supply the first voltage V1 to the second driving electrode Tx2 during the (n−1)-th driving period tn−1; and supply the second voltage V2 to the second driving electrode Tx2 during the n-th driving period tn.

In case of the m-th row of the m-th driving electrode Txm in the code matrix Mcode, the driving code is set to −A in the first driving period t1, the driving code is set to −A in the second driving period t2, the driving code is set to A in the third driving period t3, the driving code is set to A in the (n−1)-th driving period tn−1, and the driving code is set to −A in the n-th driving period tn.

Therefore, the driver 30 may supply the second voltage V2 to the m-th driving electrode Txm during the first driving period t1; supply the second voltage V2 to the m-th driving electrode Txm during the second driving period t2; supply the first voltage V1 to the m-th driving electrode Txm during the third driving period t3; supply the first voltage V1 to the m-th driving electrode Txm during the (n−1)-th driving period tn−1; and supply the second voltage V2 to the m-th driving electrode Txm during the n-th driving period tn.

The driving signal having the first or second voltage V1 or V2 may be supplied to the other driving electrodes.

For example, A may be set to 1 for convenience of calculation. In this case, the code matrix Mcode may be represented as follows:

$$[ \begin{matrix}1 & 1 & 1 & … & … & 1 & 1 \\ - 1 & 1 & - 1 & … & … & 1 & - 1 \\ 1 & - 1 & - 1 & … & … & - 1 & - 1 \\ ⋮ & ⋮ & ⋮ & & & ⋮ & ⋮ \\ ⋮ & ⋮ & ⋮ & & & ⋮ & ⋮ \\ 1 & - 1 & - 1 & … & … & 1 & 1 \\ - 1 & - 1 & 1 & … & … & 1 & - 1\end{matrix} ]$$

The controller 60 may perform a function of detecting a touch position by receiving signals output from the sensing electrodes 20. The controller 60 may be electrically coupled to the sensing electrodes 20.

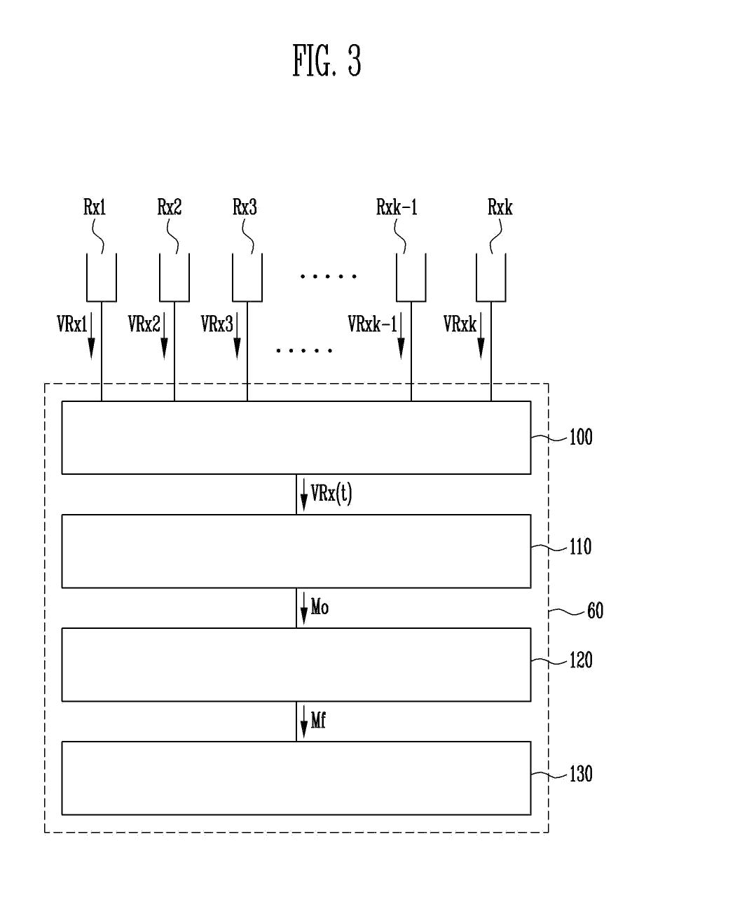

FIG. 3 is a diagram illustrating the controller according to an exemplary embodiment of the present invention.

The controller 60 may include a voltage measuring unit 100, a first calculating unit 110, a second calculating unit 120, and a touch detecting unit 130.

The voltage measuring unit 100 may measure voltages VRx1 to VRxk output from the sensing electrodes 20. In particular, the voltage measuring unit 100 may measure output voltages VRx(t) of the sensing electrodes 20 for each driving period.

For example, the output voltage VRx1 of the first sensing electrode Rx1 may be measured for each of the first driving period t1, the second driving period t2, . . . , the n-th driving period tn.

Therefore, the output voltage VRx1 of the first sensing electrode Rx1 in the first driving period t1 may be represented as VRx1(t1), the output voltage VRx1 of the first sensing electrode Rx1 in the second driving period t2 may be represented as VRx1(t2), and the output voltage VRx1 of the first sensing electrode Rx1 in the n-th driving period tn may be represented as VRx1(tn).

As such, the output voltages VRx1(t1) to VRx1(tn) for all the driving periods of the first sensing electrode Rx1 may be measured.

In addition, the output voltages VRx2 to VRxk of the other sensing electrodes Rx2 to Rxk may also be measured for each of the driving periods t1 to tn.

The first calculating unit 110 constitutes a voltage matrix Mv including output voltages VRx(t) of the sensing electrodes 20 for each driving period.

For example, the voltage matrix Mv may be generalized as the following n×1 matrix:

$$[ \begin{matrix}VRx ( t 1 ) \\ VRx ( t 2 ) \\ VRx ( t 3 ) \\ ⋮ \\ ⋮ \\ VRx ( tn - 1 ) \\ VRx ( tn )\end{matrix} ]$$

The rows of the voltage matrix Mv may correspond to the respective driving periods t1 to tn, and the columns of the voltage matrix Mv may correspond to the same single sensing electrode.

Therefore, the voltage matrix Mv1 of the first sensing electrode Rx1 may be represented as the following n×1 matrix.

$$[ \begin{matrix}VRx 1 ( t 1 ) \\ VRx 1 ( t 2 ) \\ VRx 1 ( t 3 ) \\ ⋮ \\ ⋮ \\ VRx 1 ( tn - 1 ) \\ VRx 1 ( tn )\end{matrix} ]$$

In addition, the voltage matrix Mvk of the k-th sensing electrode Rxk may be represented as the following n×1 matrix.

$$[ \begin{matrix}VRxk ( t 1 ) \\ VRxk ( t 2 ) \\ VRxk ( t 3 ) \\ ⋮ \\ ⋮ \\ VRxk ( tn - 1 ) \\ VRxk ( tn )\end{matrix} ]$$

The voltage matrices Mv2 to Mvk−1 of the other sensing electrodes Rx2 to Rxk−1 may also be configured in the same manner.

The first calculating unit 110 may calculate an output matrix Mo with respect to a specific sensing electrode by multiplying a coefficient value b, the code matrix Mcode, and the voltage matrix My of the specific sensing electrode. This may be represented by the following relational expression.

Mo=b×Mcode×Mv

In this case, the coefficient value b may be set to 1/n. Here, n is a number of columns of the code matrix Mcode.

For example, the output matrix Mo1 of the first sensing electrode Rx1 may be calculated through the following relational expression:

Mo1=b×Mcode×Mv1

In addition, the output matrix Mok of the k-th sensing electrode Rxk may be calculated through the following relational expression:

Mok=b×Mcode×Mvk

The output matrices Mo2 to Mok−1 of the other sensing electrodes Rx2 to Rxk−1 may also be configured in the same manner.

The second calculating unit 120 may calculate a final matrix Mf by subtracting a reference value ref from each element of the output matrix Mo calculated in the first calculating unit 110, and then multiplying by −1.

The output matrix Mo calculated by the first calculating unit 110 may be generalized as the following m×1 matrix:

$$[ \begin{matrix}ORx ( t 1 ) \\ ORx ( t 2 ) \\ ORx ( t 3 ) \\ ⋮ \\ ⋮ \\ ORx ( Txm - 1 ) \\ ORx ( Txm )\end{matrix} ]$$

Therefore, the final matrix Mf calculated by the second calculating unit 120 may be generalized as the following m×1 matrix:

$$[ \begin{matrix}ORx ( Tx 1 ) - ref \\ ORx ( Tx 2 ) - ref \\ ORx ( Tx 3 ) - ref \\ ⋮ \\ ⋮ \\ ORx ( Txm - 1 ) - ref \\ ORx ( Txm ) - ref\end{matrix} ]$$

Therefore, the final matrix Mf1 of the first sensing electrode Rx1 may be represented by the following m×1 matrix:

$$[ \begin{matrix}ORx 1 ( Tx 1 ) - ref \\ ORx 1 ( Tx 2 ) - ref \\ ORx 1 ( Tx 3 ) - ref \\ ⋮ \\ ⋮ \\ ORx 1 ( Txm - 1 ) - ref \\ ORx 1 ( Txm ) - ref\end{matrix} ]$$

In addition, the final matrix Mfk of the k-th sensing electrode Rxk may be represented by the following m×1 matrix:

$$[ \begin{matrix}ORxk ( Tx 1 ) - ref \\ ORxk ( Tx 2 ) - ref \\ ORxk ( Tx 3 ) - ref \\ ⋮ \\ ⋮ \\ ORxk ( Txm - 1 ) - ref \\ ORxk ( Txm ) - ref\end{matrix} ]$$

The final matrices Mf2 to Mfk−1 of the other sensing electrodes Rx2 to Rxk−1 may also be configured in the same manner.

The second calculating unit 120 may set the reference value ref in various ways.

First, the second calculating unit 120 may set the reference value ref under an external control.

Second, the second calculating unit 120 may set, as the reference value ref, the largest value from among the elements of the output matrix Mo.

Third, the second calculating unit 120 may set, as the reference value ref, the largest value from among the elements of the output matrix Mo and the average of values within a preset range from the largest value.

Fourth, the second calculating unit 120 may set, as the reference value ref, the largest value from among the elements of the output matrix Mo and the average of some values within a preset range from the largest value.

The touch detecting unit 130 may detect a touch position with respect to a specific sensing electrode by comparing the elements of the final matrix Mf with a preset critical value.

For example, when the first element among the elements included in the final matrix Mf1 of the first sensing electrode Rx1 has a value greater than the critical value, the touch detecting unit 130 may decide that a touch has been generated at the intersection point of the first sensing electrode Rx1 and the first driving electrode Tx1.

When the m-th element among the elements included in the final matrix Mf1 of the first sensing electrode Rx1 has a value greater than the critical value, the touch detecting unit 130 may decide that a touch has been generated at the intersection point of the first sensing electrode Rx1 and the m-th driving electrode Txm.

When each of the first and fourth elements among the elements included in the final matrix Mfk of the k-th sensing electrode Rxk has a value greater than the critical value, the touch detecting unit 130 may decide that touches have been respectively generated at the intersection point of the k-th sensing electrode Rxk and the first driving electrode Tx1 and the intersection point of the k-th sensing electrode Rxk and the fourth driving electrode Tx4.

In the manner described above, touch positions with respect to the other sensing electrodes Rx2 to Rxk-1 may also be detected.

Various display devices may include the touch sensor 1 according to the aforementioned exemplary embodiment of the present invention. For example, a liquid crystal display device, a field emission display device, a plasma display panel, an organic light emitting display device, and the like may be provided with the touch sensor 1 according to an exemplary embodiment of the present invention in order to perform a touch screen function.

Summarizing, according to the present invention, it is possible to provide a touch sensor and a display device including the same, which can simplify a touch detection process.

Exemplary embodiments have been disclosed herein, and although specific terms are employed, they are used and are to be interpreted in a generic and descriptive sense only and not for purpose of limitation. In some instances, as would be apparent to one of ordinary skill in the art, features, characteristics, and/or elements described in connection with a particular exemplary embodiment may be used singly or in combination with features, characteristics, and/or elements described in connection with other exemplary embodiments unless otherwise specifically indicated. Accordingly, it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A touch sensor, comprising:
driving electrodes;
sensing electrodes extending across the driving electrodes;
a memory configured to store a code matrix comprising driving codes respectively set for the driving electrodes and driving periods; and
a driver configured to supply driving signals to the driving electrodes with reference to the code matrix,
wherein:
the code matrix is configured with m rows and n columns; and
m is an integer greater than or equal to 2, and n=m−1.

2. The touch sensor of claim 1, wherein rows of the code matrix correspond to the respective driving electrodes, and columns of the code matrix correspond to the respective driving periods.

3. The touch sensor of claim 2, wherein each driving code is set to A or −A, where A is a natural number.

4. The touch sensor of claim 3, wherein A is set to 1.

5. The touch sensor of claim 3, wherein the driver is configured to supply a first voltage to a corresponding driving electrode in a corresponding driving period when a specific driving code is set to A, and to supply a second voltage to the corresponding driving electrode in the corresponding driving period when the specific driving code is set to −A.

6. The touch sensor of claim 5, wherein the first and second voltages are set to have the same absolute value and opposite polarities.

7. The touch sensor of claim 1, further comprising a voltage measuring unit configured to measure output voltages of the sensing electrodes for each driving period.

8. The touch sensor of claim 7, further comprising a first calculating unit configured to calculate an output matrix with respect to the specific sensing electrode by multiplying a coefficient value, the code matrix, and an output voltage of the specific sensing electrode for each driving period.

9. The touch sensor of claim 8, wherein the coefficient value=1/n.

10. The touch sensor of claim 8, further comprising a second calculating unit configured to calculate a final matrix with respect to the specific sensing electrode by subtracting a reference value from each element of the output matrix, and then multiplying by −1.

11. The touch sensor of claim 10, wherein the second calculating unit sets, as the reference value, the largest value from among the elements of the output matrix.

12. The touch sensor of claim 10, wherein the second calculating unit is configured to determine the largest value among the elements of the output matrix and at least one value from values within a preset range from the largest value among the elements of the output matrix and set, as the reference value, an average value of values including the largest value from among the elements of the output matrix and the at least one value from values within a preset range from the largest value among the elements of the output matrix.

13. The touch sensor of claim 10, further comprising a touch detecting unit configured to detect a touch position with respect to the specific sensing electrode by comparing the elements of the final matrix with a critical value.

14. The touch sensor of claim 1, wherein the driving electrodes and the sensing electrodes comprise a transparent conductive material.

15. A display device comprising the touch sensor of claim 1.
